(19) United States
(12) Patent Application Publication
(10) Pub. No.: US 2026/0031886 A1
(43) Pub. Date: Jan. 29, 2026

(54) TECHNOLOGIES FOR BEAM REPORT TRANSMISSION

(71) Applicant: Apple Inc., Cupertino, CA (US)

(72) Inventors: Hong He, San Jose, CA (US); Qiming Li, Beijing (CN); Dawei Zhang, Saratoga, CA (US); Wei Zeng, Saratoga, CA (US); Chunxuan Ye, San Diego, CA (US); Ankit Bhamri, Haar (DE); Oghenekome Oteri, San Diego, CA (US)

(73) Assignee: Apple Inc., Cupertino, CA (US)

(21) Appl. No.: 19/246,647

(22) Filed: Jun. 23, 2025

Related U.S. Application Data
(60) Provisional application No. 63/674,758, filed on Jul. 23, 2024.

(51) Int. Cl. H04B 7/06; H04L 1/1812; H04L 27/26; H04W 72/0453; H04W 72/21

(52) U.S. Cl. CPC H04B 7/06952; H04B 7/0626; H04L 1/1812; H04L 27/2607; H04W 72/0453; H04W 72/21

(57) ABSTRACT

The present application relates to devices and components including apparatus, systems, and methods for measurements for user equipment-initiated beam reporting.

### CROSS-REFERENCE TO OTHER APPLICATION

This application claims priority to U.S. Provisional Application No. 63/674,758, for “TECHNOLOGIES FOR BEAM REPORT TRANSMISSION” filed on Jul. 23, 2024, which is herein incorporated by reference in its entirety for all purposes.

### TECHNICAL FIELD

This application relates generally to communication networks and, in particular, to measurements for user equipment-initiated beam reporting.

### BACKGROUND

Third Generation Partnership Project (3GPP) Technical Specifications (TSs) define standards for wireless networks. These TSs describe aspects related to user plane and control plane signaling over the networks.

### BRIEF DESCRIPTION OF THE DRAWINGS

FIG. 1 illustrates a network environment in accordance with some embodiments.

FIG. 2 illustrates control information in accordance with some embodiments.

FIG. 3 illustrates a timing diagram in accordance with some embodiments.

FIG. 4 illustrates another control information in accordance with some embodiments.

FIG. 5 illustrates a resource list in accordance with some embodiments.

FIG. 6 illustrates another timing diagram in accordance with some embodiments.

FIG. 7 illustrates a prioritization diagram in accordance with some embodiments.

FIG. 8 illustrates report contents in accordance with some embodiments.

FIG. 9 illustrates options for measurement signal indexing in accordance with some embodiments.

FIG. 10 illustrates an operation flow/algorithmic structure in accordance with some embodiments.

FIG. 11 illustrates another operation flow/algorithmic structure in accordance with some embodiments.

FIG. 12 illustrates a user equipment in accordance with some embodiments.

FIG. 13 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry,” as used herein, refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry,” as used herein, refers to, is part of, or includes circuitry capable of sequentially and automatically carrying out a sequence of arithmetic or logical operations, recording, storing, or transferring digital data. The term “processor circuitry” may refer to an application processor, baseband processor, central processing unit (CPU), graphics processing unit, single-core processor, dual-core processor, triple-core processor, quad-core processor, or any other device capable of executing or otherwise operating computer-executable instructions, such as program code, software modules, or functional processes.

The term “interface circuitry,” as used herein, refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any transmission medium, either tangible or intangible, that is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, or a virtualized network function.

The term “information element” refers to a structural element containing one or more fields. The term “field” refers to individual contents of an information element or a data element that contains content. An information element may include one or more additional information elements.

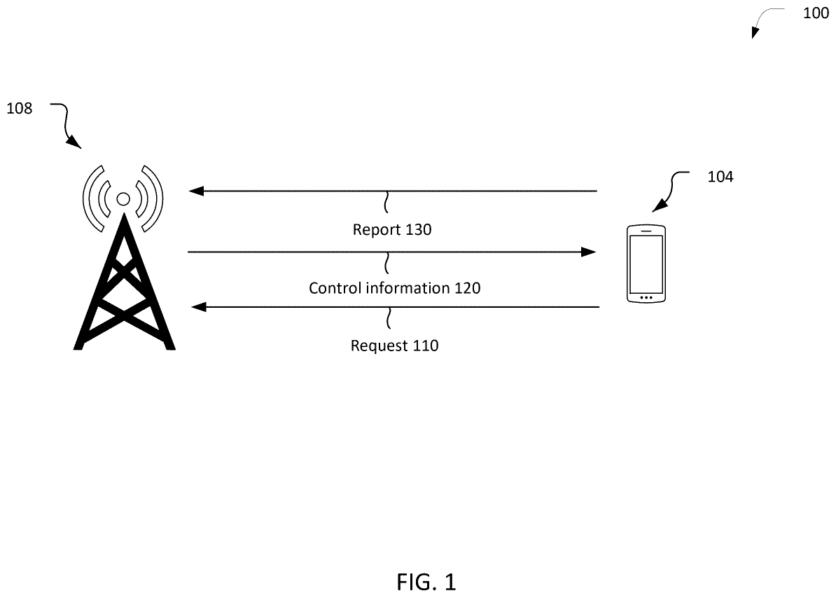

FIG. 1 illustrates a network environment 100 in accordance with some embodiments. The network environment 100 may include a UE 104 coupled with a base station (BS) 108 of a radio access network (RAN) 110 that provides one or more serving cells. In some embodiments, the BS 108 is a gNB that provides one or more 3GPP NR cells. The air interface over which the UE 104 and the base station 108 communicate may be compatible with 3GPP technical specifications (TSs), such as those that define 5G NR or later system standards (e.g., Sixth Generation (6G) standards). RAN 110 may include a number of base stations (e.g., the base stations 108 and 118) or other access nodes that provide services to various UEs through serving cells.

The RAN 110 and UE 104 may perform various beam management procedures to identify and maintain a set of desired beams for uplink and downlink communications. Beam management may be performed using various reference signals. Downlink reference signals may include, for example, synchronization signal blocks (SSBs) and channel state information (CSI)-reference signals (CSI-RSs). Uplink reference signals may include, for example, sounding reference signals (SRSs).

In legacy beam management procedures, a network may configure/activate frequent periodic or semipersistent beam reporting (e.g., K best beams and corresponding layer 1—reference signal received powers (L1-RSRPs)) or trigger frequent aperiodic beam reporting to timely acquire the best/preferred beam for data/control transmissions. However, this may result in a large overhead in terms of both uplink reporting and control signaling. However, if less frequent beam reporting is configured, the network may not be able to acquire the ‘best/preferred’ beam(s) as the beam reporting by the UE may be outdated, thus leading to performance degradation.

Given that the UE 104 has better and more timely knowledge of beam quality changes, some embodiments describe UE-initiated beam report (UEIBR) procedures that can lead to more timely beam reports and still reduce reporting overhead. Embodiments of the present disclosure address various issues relating to UEIBR procedures.

A first issue may relate to the design of downlink control signaling to provide resources for UEIBR. Depending on the contents of the UEIBR, different channels may be utilized to transmit the UEIBR. Some aspects of the present disclosure describe the downlink control information (DCI) format design for allocating and granting transmission occasions and other resources for UEIBR.

A second issue may relate to the possibility that a UEIBR report collides with other uplink control information (UCI), including hybrid automatic repeat request (HARQ)-acknowledgment (ACK), network-initiated (NWI)-CSI feedback, e.g., L1-RSRP, or other CSI types. Some aspects of the present disclosure describe how to resolve the collision between UEIBR and other UCI.

A third issue may relate to UEIBR for carrier aggregation (CA) or connectivity to more than one cell (e.g., dual connectivity (DC)). Some aspects describe the measurement resource set structure as being used to increase flexibility and reduce signaling overhead. Other aspects describe configuring the measurement resource sets for the candidate beam and managing the UEIBR content size.

In some embodiments, the base station 108 may dynamically schedule UCI (e.g., the UEIBR). In the first step, the UE 104 may send a request 110 to base station 108. Request 110 may be a scheduling request or a new UCI type having one or more bits.

In response to request 110, base station 108 may send configuration information 120 to UE 104. UE 104 may detect and process the control information 120 and determine that the control information 120 indicates a resource for an UL channel to carry report 130, e.g., UEIBR. The control information 120 may be DCI. The UL channel may be a physical uplink control channel (PUCCH) or a physical uplink shared channel (PUSCH).

UE 104 may generate and transmit report 130 (e.g., the UEIBR) in UL channel resources granted by the control information 120.

In some instances, the control information 120 may include a legacy DCI format repurposed to grant uplink resources for the transmission of UEIBR. In other instances, the control information 120 may include a new DCI format or fields for enabling resource allocation and grant for transmission of UEIBR.

In some embodiments, collision resolution procedures are described to resolve collisions between UEIBR and other UCIs. In some instances, the collision resolution may be based on the priority order of colliding information. In other instances, the collision resolution may be specified by 3GPP specifications or configured by control signaling.

In some embodiments, different approaches are described to configure measurement resources for different component carriers (CCs) or cells for UEIBR. In some instances, the measurement resource set may be configured independently for each cell or CC. In other instances, the measurement resources may be configured across multiple CCs or cells.

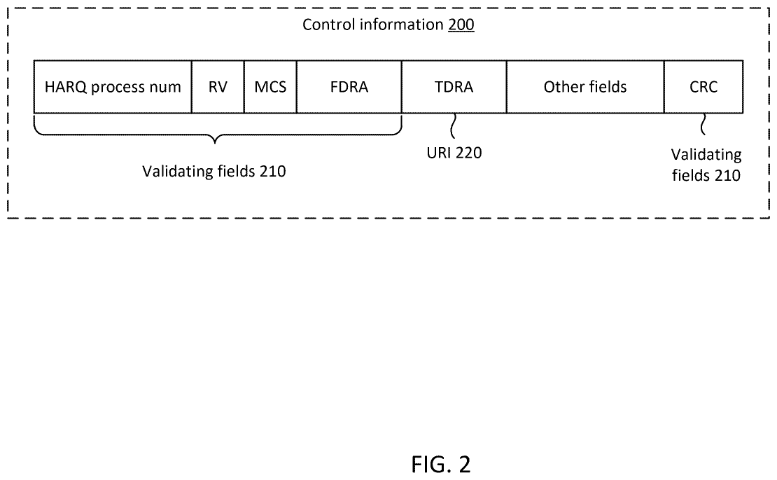

FIG. 2 illustrates control information 200 in accordance with some embodiments. Control information 200 may be an example of a legacy DCI format being repurposed to support resource allocation for UEIBR. FOR example, the control information 200 may be a DCI format 0_X.

The control information 200 may be used to dynamically select a transmission occasion (TO) from a plurality of PUCCH or configured grant (CG)-PUSCH TOs within a time window.

One or more of the legacy fields, e.g., HARQ process number field, redundancy version (RV) field, modulation and coding schemed (MCS) field, frequency-domain resource allocation (FDRA) field, time-domain resource allocation (TDRA) field, or cyclic redundancy check (CRC) field may be repurposed as validating fields 210.

Upon receiving and processing the control information 200, UE 104 may validate the DCI format indicating UL channel to carry the UEIBR if one or more of these fields take a predefined value. For example, one or a combination of the following fields and predefined values for the DCI format may be used as validating fields 210: HARQ process number filed set to all ‘0’s, RV field set to all ‘0’s, MCS field set to all ‘1’s, FDRA field set to all ‘0’s for FDRA Type-2 and set to all ‘1’s for FDRA Type-1.

Alternatively, or additionally, UE 104 may validate the DCI format indicating UL channel to carry the UEIBR if the CRC field is scrambled with a predefined radio network temporary identifier (RNTI). For example, the UE 104 may validate the DCI format indicating an UL channel to carry the UEIBR if the CRC of the control information 200 is scrambled with a Cell-RNTI (C-RNTI).

One or more configurable fields of the control information 200 may be repurposed or configured as an uplink resource indicator (URI), e.g., URI 220. The URI may specify which PUCCH or PUSCH resources UE 104 may use for its uplink data transmission. In one example, the TDRA field may be reconfigured/repurposed as the URI field. Values within the validating fields 210 may be used to indicate whether the configurable field is a TDRA field or a URI field.

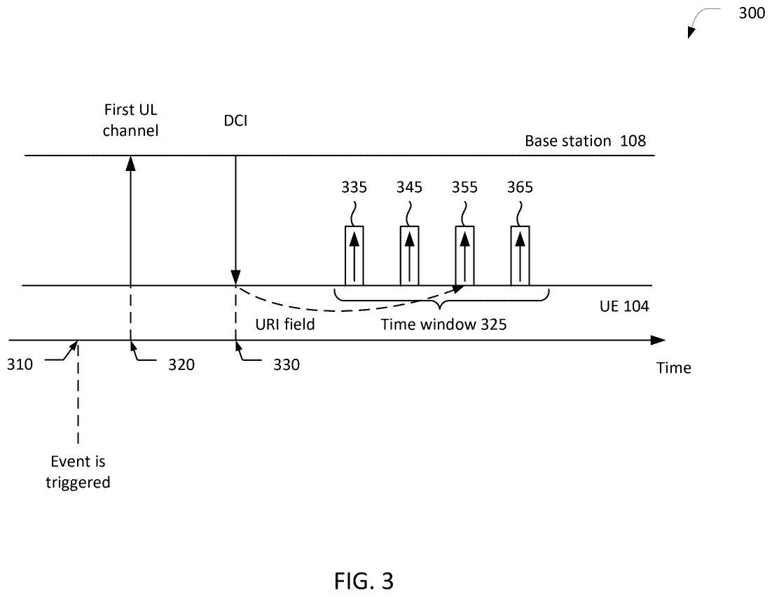

FIG. 3 illustrates a timing diagram 300 in accordance with some embodiments. Timing diagram 300 is an example of signaling for scheduling UEIBR using a repurposed DCI format to dynamically select a TO from a plurality of PUCCH or CG-PUSCH TOs. The repurposed DCI format may be a DCI format 0_X.

At 310, the UE 104 may detect a triggering event. The triggering event may be a specific condition or criteria that, when met, prompts the UE 104 to report beam-related information to the base station 108. Specific conditions may include a change in beam quality, signal strength, mobility event (e.g., handover), or predefined time intervals. In some instances, the triggering events are designed to ensure timely and efficient beam status reporting to maintain service quality and network performance.

At 320, the UE 104 may generate and send a message on a first UL channel, e.g., a PUSCH or a PUCCH. The message may request a resource for an uplink channel (e.g., a PUSCH or a PUCCH) to carry the UEIBR.

Base station 108 may configure UE 104 with time window 325 and transmission occasions 335, 345, 355, and 365. Base station 108 may use RRC signaling to configure time window 325 and transmission occasions 335, 345, 355, and 365. The time window length and offset between the DCI format 0_X and the first valid TO may be configured by RRC signaling.

The time window 325 may define the time interval that includes uplink resources that may be selected/used by the UE 104 for uplink transmissions. Transmission occasions (e.g., TOs 335, 345, 355, and 365) may be specific and configured time instances, slots, or resources within a given time window (e.g., time window 325) when the UE 104 is permitted to transmit data. Base station 108 may configure UE 104 with the time window or one or more transmission occasions within the time window. For example, base station 108 may use RRC signaling to configure the time window or one or more transmission occasions within the time window.

At 330, base station 108 may generate and transmit the DCI format, and UE 104 may detect, receive, and process the DCI format. UE 104 may examine the value of validating fields (e.g., validating fields 210 in FIG. 2) and determine that the DCI format indicates an UL channel to carry the UEIBR.

The UE 104 may identify the configurable field as a URI field (e.g., the URI field 220 in FIG. 2) based on the values of the validating fields. The URI field may indicate a configured transmission occasion (e.g., transmission occasion 355) that is to be used for UEIBR transmission.

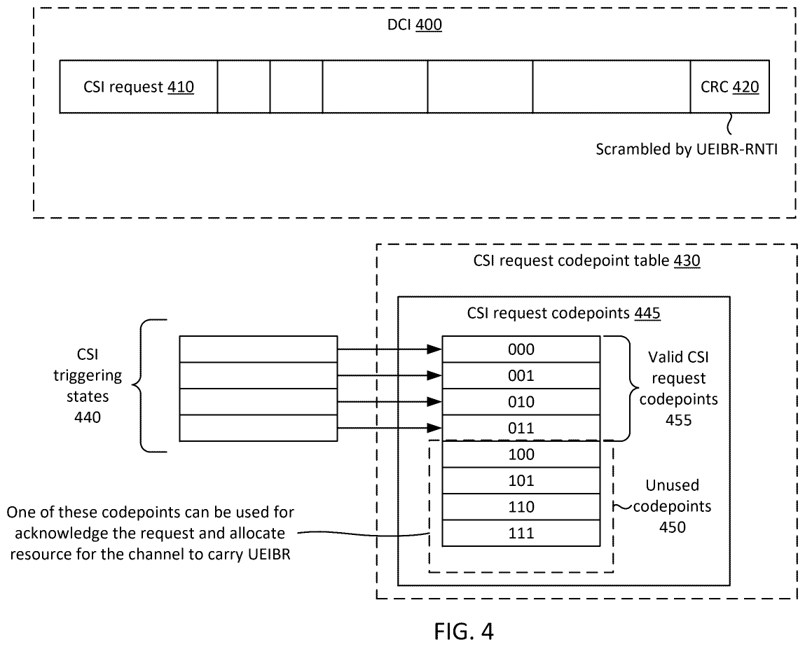

FIG. 4 illustrates another control information 400 in accordance with some embodiments. The control information 400 may be an example of legacy DCI format 0_1 repurposed to indicate the UL channel for UEIBR content report.

The control information 400 may include a CSI request field 410 and CRC field 420. The CSI request field 410 may contain a CSI request codepoint from the CSI request codepoint table 430. The codepoint in CSI request field 410 may determine the requested CSI report.

Base station 108 may detect a CSI triggering state from a CSI aperiodic CSI state list 440. The CSI aperiodic CSI state list 440 is shown with four CSI triggering states. Based on the detected CSI triggering state, base station 108 may select a corresponding CSI request codepoint from the CSI request codepoint 445 of the CSI request codepoint table 430. Base station 108 may generate the DCI 400 by setting the CSI request field 410 with the selected codepoint. CSI aperiodic triggering state list 440 or CSI request codepoint table 430 may be configured by RRC signaling.

In some instances, the number of valid CSI request codepoints 455 is the same as the number of configured CSI triggering states in the CSI aperiodic trigger state list 440. One or more of CSI request codepoints 445 in the CSI request codepoint table 430 may be unused codepoints 450. An unused codepoint may be a codepoint that is not used to trigger any periodic CSI report based on the RRC configuration. For example, with the CSI aperiodic CSI state list 440 having four states, the unused codepoints 450 may include four codepoints (e.g., 100, 101, 110, and 111).

In some embodiment, CSI request field 410 may be repurposed as a validating field. For example, if the CSI request field 410 contains one of the unused codepoints 450, it may indicate that the DCI 400 is used to allocate resources for UEIRB. For example, if the UE 104 determines that the CSI request 410 includes a ‘111’ codepoint (or one of the other unused codepoints 450), the UE 104 may determine the DCI 400 is being repurposed from legacy DCI 0_X to indicate resources for UEIBR.

In some embodiments, CRC field 420 may be used to indicate the DCI 400 is being repurposed from legacy DCI 0_X to indicate resources for UEIBR. Base station 108 may scramble the CRC field 420 with a UEIBR-RNTI. Base station 108 may also configure the UE with the UEIBR-RNTI using, e.g., RRC signaling. UE 104 may check and determine that the CRC field 420 is scrambled with UEIBR-RNTI and validate that the DCI 400 may indicate resources for UEIBR. In some instances, base station 108 may scramble the CRC field 420 to acknowledge the successful reception of the message from UE 104 requesting the resources for UEIBR.

In some embodiments, a predefined value of CSI request 410 may indicate that the DCI 400 allocates resources for the UL channel to carry UEIBR. For example, when CSI request field 410 is set to all ‘0’s, it may indicate that a configurable field configured as the URI in the DCI 400 may allocate resources for the UL channel to carry UEIBR.

In some embodiments, a combination of scrambling the CRC field 420 with UEIBR-RNTI and a predefined value of CSI request 410 may be used to validate that the DCI 400 is used to allocate a channel to carry UEIBR. In another embodiment, a combination of scrambling the CRC field 420 with UEIBR-RNTI and unused codepoint in CSI request 410 may be used to validate that the DCI 400 is used to allocate a channel to carry UEIBR.

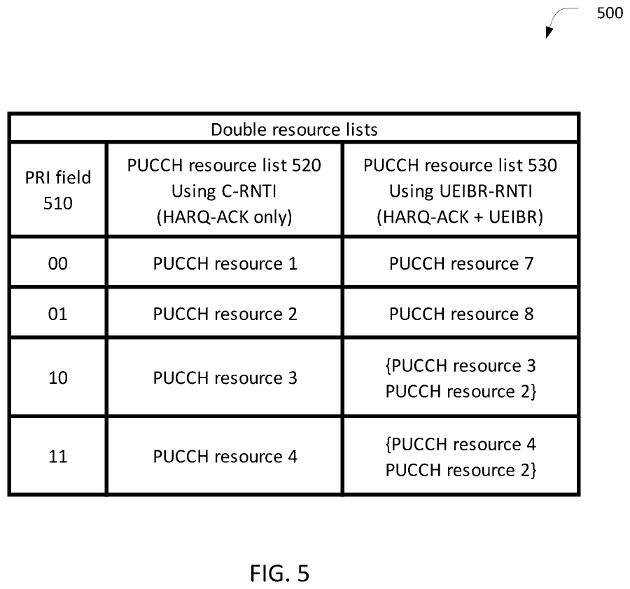

FIG. 5 illustrates resource lists 500 in accordance with some embodiments. The resource lists 500 provides an example of a configuration that associates a PUCCH resource indicator (PRI) field 510 with various PUCCH resources. The resource lists 500 may be configured by the base station 108 using RRC signaling, for example. Additionally, or alternatively, the resource lists 500 may be predefined in, for example, a 3GPP TS.

The resource lists 500 may include two separate PUCCH resource lists, e.g., PUCCH resource lists 520 and 530. One list, e.g., PUCCH resource list 520, may be associated with the HARQ-ACK report, and one list, e.g., PUCCH resource list 530, may be associated with the UEIBR and HARQ-ACK report.

Each codepoint of the PRI field 510 may be mapped to an entry of the PUCCH resource lists 520 and 530. For example, PRI codepoint ‘00’ is mapped to “PUCCH resource 1” in PUCCH resource list 520 and to “PUCCH resource 7” in PUCCH resource list 530.

In some instances, two PUCCH resources may be associated with a single PRI codepoint, e.g., codepoints ‘10’ and ‘11.’ PRI codepoint ‘01’ is associated with PUCCH resource 3 and PUCCH resource 2 in PUCCH resource list 530. PUCCH resource 3 may be used for HARQ-ACK feedback, and PUCCH resource 2 may be used for UEIBR. Similarly, PRI codepoint “11” is associated with PUCCH resources 4 and 2 in PUCCH resource list 530. PUCCH resource 4 may be used for HARQ-ACK feedback, and PUCCH resource 2 may be used for UEIBR.

In some instances, one PUCCH resource may be associated with a single PRI codepoint, e.g., codepoints ‘00’ and ‘01.’ PRI codepoint ‘00’ is associated with PUCCH resource 1 in PUCCH resource list 520 and PUCCH resource 7 in PUCCH resource list 530. When UE 104 receives a PRI codepoint ‘00’ and determines that bits of the CRC field of the DCI format are scrambled by C-RNTI, UE 104 may determine that the PRI codepoint is associated with PUCCH resource 1 that carries HARQ-ACK only. Similarly, when UE 104 receives a PRI codepoint ‘00’ and determines that bits of the CRC field of the DCI format are scrambled by UEIBR-RNTI, UE 104 may determine that the PRI codepoint is associated with PUCCH resource 7 that carries both HARQ-ACK and UEIBR. UE 104 may jointly encode HARQ-ACK and UEIBR and generate the payload to be carried by PUCCH resource 7.

Similarly, PRI codepoint ‘01’ is associated with PUCCH resource 2 in PUCCH resource list 520 and PUCCH resource 8 in PUCCH resource list 530. When UE 104 receives a PRI codepoint ‘01’ and determines that bits of the CRC field of the DCI format are scrambled by C-RNTI, UE 104 may determine that the PRI codepoint is associated with PUCCH resource 2 that carries HARQ-ACK only. Similarly, when UE 104 receives a PRI codepoint ‘01’ and determines that bits of the CRC field of the DCI format are scrambled by UEIBR-RNTI, UE 104 may determine that the PRI codepoint is associated with PUCCH resource 8 that carries both HARQ-ACK and UEIBR. UE 104 may jointly encode HARQ-ACK and UEIBR and generate the payload to be carried by PUCCH resource 8.

In some embodiments, the selection of the PUCCH resource list 520 or 530 may be indicated based on the RNTI used to scramble CRC bits of the DCI format. For example, if CRC bits of the DCI format, e.g., DCI format 1_X, are scrambled by a C-RNTI, PUCCH resource list 520 is used, and the PUCCH resource indicated by the PRI is used for HARQ-ACK feedback only. Alternatively, if the CRC bits are scrambled by a UEIBR-RNTI, PUCCH resource list 530 is used, and the PUCCH resource indicated by the PRI is used for HARQ-ACK feedback and UEIBR. If PUCCH resource list 530 is used and the PRI indicates two PUCCH resources, the UE may use a first one of the indicated resources for HARQ-ACK feedback and a second one of the indicated resources for UEIBR, as discussed above.

When UE 104 determines that the CRC field of the DCI format is scrambled by UEIBR-RNTI, UE 104 may determine that the PRI field is configured as URI. In this example, the functionality of the PRI field is not changed. Instead, resource table 500 may reconfigure the allocated resources for UEIBR from that of the legacy application, e.g., HARQ-ACK reporting.

In another embodiment, the DCI format may include a flag field (e.g., one bit), e.g., a new bit added to DCI format 1_X, to associate the indicated PUCCH resources (by DCI URI/PRI) with one of the PUCCH resource lists 520 or 530. For example, a value ‘0’ of the flag field may indicate that the PUCCH resources (indicated by DCI URI/PRI) are associated with the PUCCH resource list 520, e.g., used for HARQ-ACK feedback only. Similarly, a value ‘1’ of the flag field may indicate that the PUCCH resources (indicated by DCI URI/PRI) are associated with the PUCCH resource list 530, e.g., used for HARQ-ACK feedback and UEIBR.

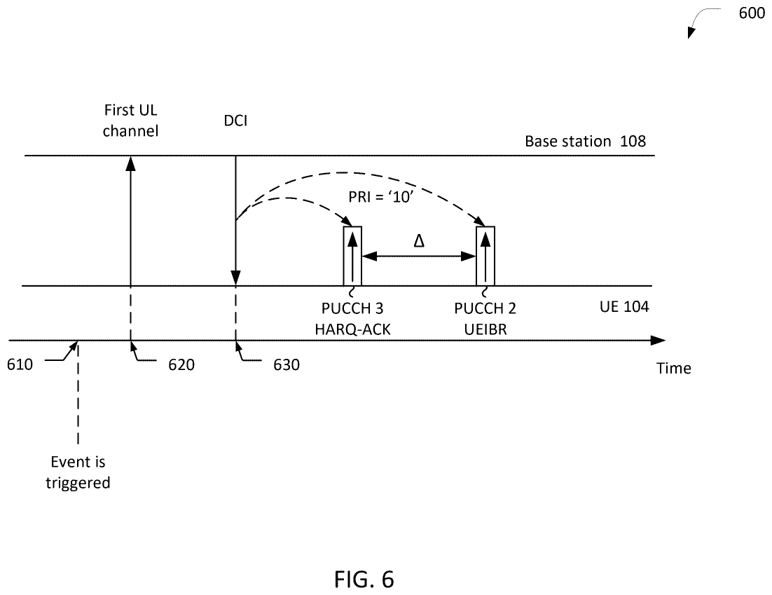

FIG. 6 illustrates another timing diagram 600 in accordance with some embodiments. Timing diagram 300 is an example of signaling for scheduling UEIBR when UE 104 is configured with two sets of PUCCH resources, as described in FIG. 5.

Time instances 610 and 620 are similar to time instances 310 and 320 in FIG. 3, and a similar description may apply.

At 630, base station 108 may generate and transmit the DCI format to UE 104. The DCI format may include a PRI field. UE 104 may determine that PUCCH resources indicated by the PRI field are used for HARQ-ACK feedback and UEIBR, e.g., via flag field or determining that the CRC bits are scrambled by UEIBR-RNTI.

In some embodiments, a single PRI codepoint may be associated with two or more PUCCH resources, e.g., PRI codepoints ‘10’ and ‘11’ in FIG. 5. For example, the DCI format at 630 may include a PRI codepoint (e.g., PRI=‘10’) associated with two PUCCH resources, e.g., PUCCH 3 for HARQ-ACK feedback and PUCCH 2 for UEIBR.

In some instances, a slot offset value ‘4’ may be hard-encoded in the specification or explicitly configured as part of the PUCCH resource configuration. The UEIBR is transmitted in PUCCH 2 in slot n+Δ, where n is the slot where the first PUCCH resource is transmitted.

Various embodiments describe different priority rules being defined to handle overlapping between UEIBR UCI and other UCIs, including HARQ-ACK and a legacy CSI report triggered/configured by the network (NW-initiated CSI, NWI-CSI). A collision (or overlap) between a first UCI and a second UCI may refer to a collision between the schedule or resources (e.g., time or frequency resource) of the two UCIs.

In some embodiments, if the UE 104 detects a collision between UEIBR and a HARQ-ACK report, the UE 104 may jointly encode the UEIBR payload with HARQ-ACK bits.

In some embodiments, if UEIBR collides with NWI-CSI, one or more of the following two options may be used to resolve the collision.

In option 1, UEIBR is always prioritized over any NWI-CSI report, and the NWI-CSI report may be dropped. In some instances, if a plurality of UEIBR reports collide, the overlapping UEIBR reports may be concatenated in increasing order of event identifier (ID). In some instances, the event ID may be included in each UEIBR report before concatenation.

It is possible that the concatenated payload exceeds the maximum number of bits that can be carried by the allocated UL resource. In some embodiments, a UEIBR report associated with a lower event ID may be prioritized over a UEIBR report with a higher event ID. The UEIBR report with a higher event ID may then be dropped. For example, the UEIBR report with the largest event ID may be dropped first. If the remaining payload still exceeds the maximum number of bits that can be carried by the allocated UL resources, the UEIBR report with the second largest event ID may be dropped next. The process repeats until the payload is smaller than or equal to the maximum number of bits that can be carried by the allocated UL resources.

In some embodiments, the priority order of the UEIBR report of a given event may be explicitly configured by RRC signaling. Base station 108 may send an RRC signaling to UE 104 to configure the UE with priority order associated with each event ID.

In option 2, priority order may be defined based on the report type (e.g., periodic or semi-persistent report) or report content (e.g., L1-RSRP).

In some embodiments, the priority order may be defined based on the report type. For example, when UEIBR collides with aperiodic NWI-CSI, the following rules may be applied. In some embodiments, a report that includes results for PCell or PSCell may have priority over a report that is not associated with PCell or PSCell. For example, if a first UEIBR that is associated with a PCell collides with a second UEIBR and NWI-CSI that are associated with various SCells, the first UEIBR may have priority over the second UEIBR and the NWI-CSI based on it being associated with the PCell.

In some embodiments, the priority order may be defined based on the cell ID. For example, a report associated with a lower cell ID may be prioritized over a report associated with a higher cell ID.

In some embodiments, RRC signaling may be used to configure priority order between UEIBR and NW-CSI. The prioritization order may depend on the event associated with the report.

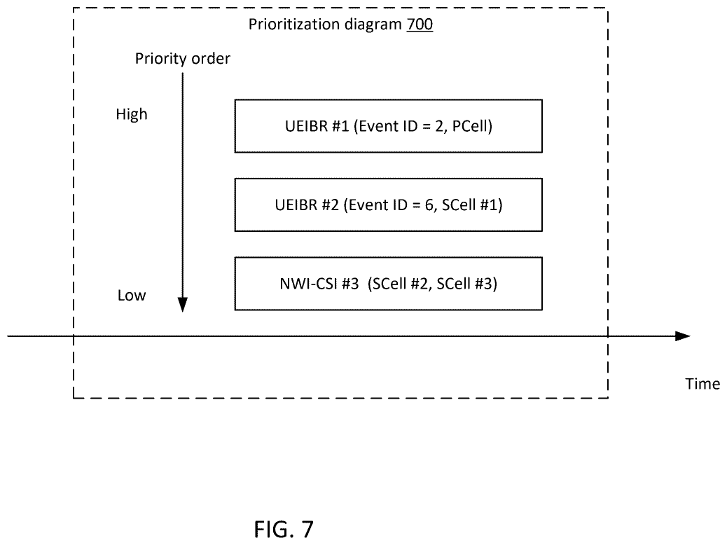

FIG. 7 illustrates a prioritization diagram 700 in accordance with some embodiments. Prioritization diagram 700 is an example of three UCI types overlapping. In particular, the prioritization diagram shows UEIBR #1 triggered by event 2 for PCell, UEIBR #2 triggered by event 6 for SCell #1, and the NWI-CSI report including results for SCell #2 and SCell #3.

Based on the rules of option 1 discussed above, UEIBR #1 and #2 overlap and, therefore, their reports may be concatenated in increasing order of event identifier (ID). For example, a payload may be obtained by adding UEIBR #1, with event ID=2, to the payload first and then adding UEIBR #2, with event ID=6, to the payload.

Based on the rules of option 2 discussed above, the NWI-CSI is dropped in case the total number of bits {UEIBR #1, UEIBR #2, NWI-CSI} exceeds the payload of the allocated PUSCH. The payloads of {UEIBR #1, UEIBR #2} are concatenated, and if it does not exceed the payload of the allocated PUSCH, they are transmitted over the allocated resources.

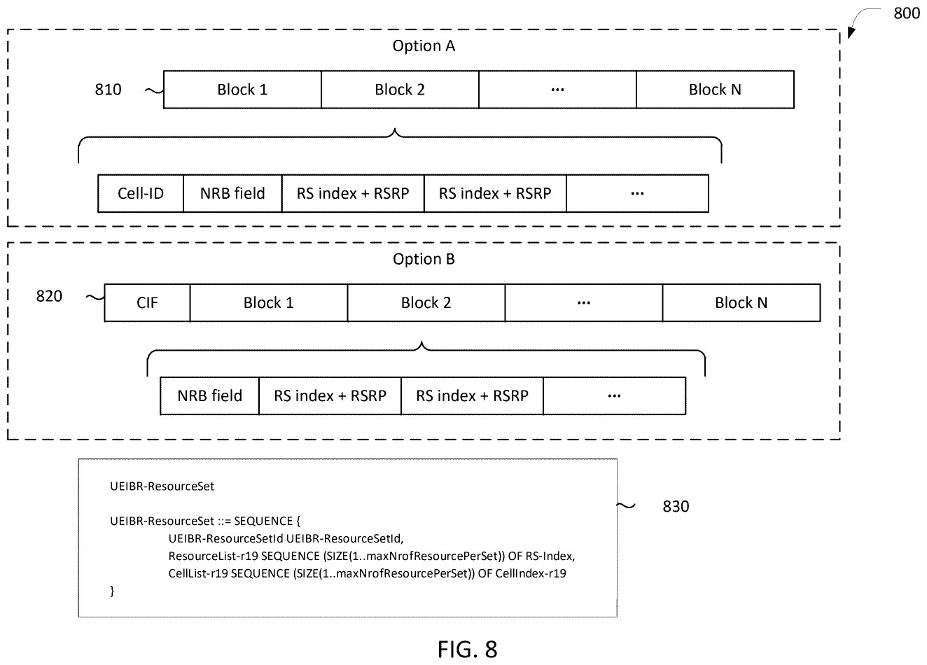

FIG. 8 illustrates report contents 800 in accordance with some embodiments. Different approaches may be considered to configure measurement resources, e.g., synchronization signal block (SSB) or CSI-reference signal (RS) resources, for different CCs or cells for the UEIBR.

In some embodiments, base station 108 may configure the UE 104 with the measurement resource set. Base station 108 may independently configure a measurement resource seat for each cell or CC. The measurement resources may be used to measure L1-RSRP. The L1-RSRP result and corresponding CC or cell may be reported in UEIBR reports. There are different options for report contents 800.

In option A, the UEIBR report 810 may include several blocks, e.g., Block 1, Block 2, . . . , Block N. Each block may include several fields or sub-fields. For example, each block may include a field to indicate a cell ID, a number of reported beams (NRB), and a pair of {RS index, measurement result} for each reported beam. In some instances, the measurement result may be L1-RSRP. In some instances, there is no need for an NRB field when the number of reported beams is configured by the network, e.g., via RRC signaling.

In option B, the UEIBR report 820 may include a cell indicator field (CIF) to indicate the CCs or cells whose measurement results are reported and included in the UEIBR report 820. In some instances, the CIF may be a bitmap. Each bit in the CIF bitmap may be associated with a CC or a cell. A value of ‘1’ in the CIF bitmap may indicate that a measurement result of the corresponding CC or cell is included in the UEIBR. The number of blocks after the CIF field in the report may be equal to the number of Is in the CIF bitmap. Each block may include one or more fields. For example, each block may include an NRB field or a pair of {RS index, measurement result} for each reported beam. In one example, the measurement result may be L1-RSRP.

IE 830 is an example of an information element configuring a measurement resource set for UEIBR. The measurement resource set may be configured across multiple CCs or cells. For example, base station 108 may configure UE 104 with the measurement resource set via RRC signaling. UE 104 may report the RS index, where RS index k may correspond to the configured k+1-st entry of the associated CSI resource set configured by the ResourceList-r19 parameter.

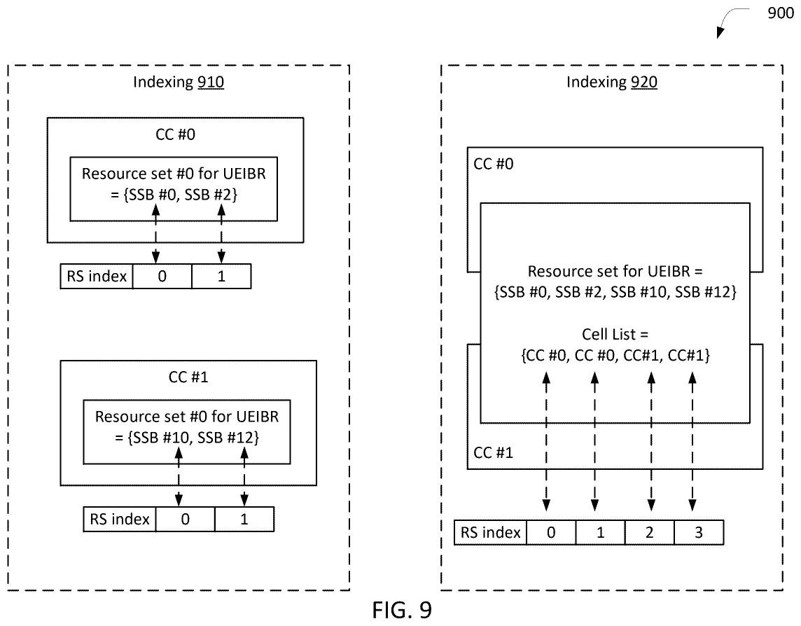

FIG. 9 illustrates options 900 for measurement signal indexing in accordance with some embodiments. Signaling indexing 910 is an example of indexing compatible with option A, and indexing 920 is based on option B, where options A and B are described above in FIG. 8.

In indexing 910, reference signals are indexed per cell. RS indexing across cells may cause overlap among RS indices, e.g., RS index #0 and #1 are used for both CC #0 and CC #1. As a result, a cell ID may be included so the network can identify the corresponding CC index for a reported RS index.

For example, CC #0 is associated with resource set #0 for UEIBR, where resource set #0 includes SSB #0 and SSB #2. SSB #0 in the CC #0 configuration has RS index #0, and SSB #2 in the CC #0 configuration has RS index #1. Similarly, CC #1 is associated with resource set #1 for UEIBR, where resource set #1 includes SSB #10 and SSB #12. SSB #10 in the CC #1 configuration has RS index #0, and SSB #12 in the CC #0 configuration has RS index #1.

In indexing 920, reference signals are indexed across multiple CCs or cells. The RS may also be indexed per resource set across cells or CCs. The RS index may be unique across all involved CCs or cells. In this case, there is no need to include cell ID in the UEIBR report. RS index alone may be sufficient.

For example, the resource set #0 may be configured for UEIBR, including a list of resources, e.g., {SSB #0, SSB #2, SSB #10, and SSB 12}. Another parameter, e.g., a cell list parameter, CellList-r19 of the IE 830 in FIG. 8, may include a list of cells associated with the resources in the list of resources. For example, the cell list may include {CC #0, CC #0, CC #1, CC #1}. The one-to-one correspondence between the list of resources and the cell list main indicated that SSB #0 is associated with CC #0, SSB #2 is associated with CC #0, SSB #10 is associated with CC #1, and SSB #12 is associated with CC #1.

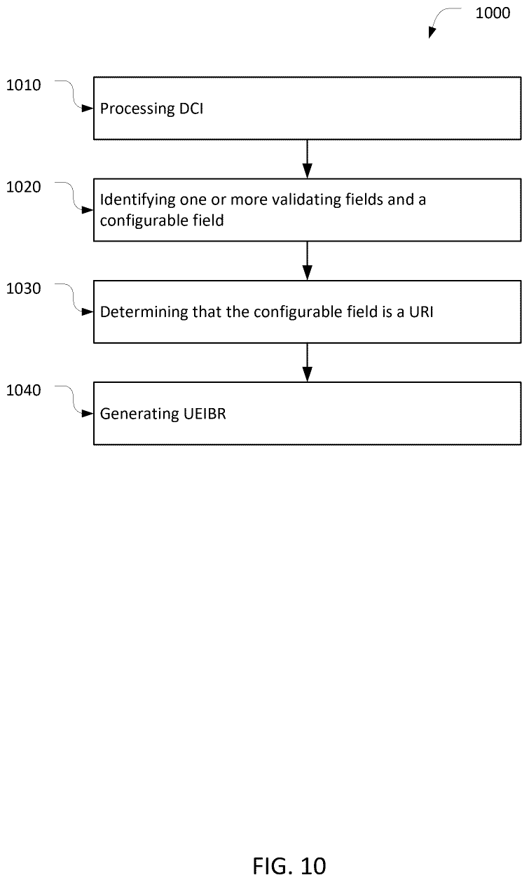

FIG. 10 illustrates an operation flow/algorithmic structure 1000 in accordance with some embodiments. The operation flow/algorithmic structure 1000 may be performed or implemented by a UE such as, for example, the UE 104 or UE 1200; or components thereof, for example, baseband processor circuitry 1204A.

The operation flow/algorithmic structure 1000 may include, at 1010, processing DCI. The DCI may be a legacy DCI format, such as DCI format 0_X or 1_0, in which one or more of its fields are reconfigured and used for a different purpose than is originally intended and used. In some embodiments, new fields may be introduced or configured. For example, a flag bit field may be introduced or configured. The new field may use reserved fields or bits in a legacy DCI format. In some embodiments, a new DCI format may be specified and used.

The operation flow/algorithmic structure 1000 may include, at 1020, identifying one or more validating fields and a configurable field. One or more validating fields may be used to validate that the DCI format is used to allocate resources for UEIBR. One or more validating fields may include the following legacy fields: a HARQ process number field, an RV field, an MCS field, an FDRA field, a CRC field, a CSI request field, or other fields.

The configurable field may be another field with functionality that is different from a field in legacy DCI format for scheduling UEIBR. When the DCI format is configured to be used for allocating resources for UEIBR, the configurable field is configured as a URI field indicating the resources allocated for UEIBR transmission. For example, the configurable field may be the TDRA field, PRI field, or other fields in the legacy DCI formats that are configured and repurposed as URI for UEIBR.

The operation flow/algorithmic structure 1000 may include, at 1030, determining that the configurable field is a URI. UE 104 may validate that the configurable field is a URI; accordingly, the DCI format allocates resources for UEIBR based on the value of one or more validating fields. In some embodiments, the UE 104 may determine that one or more validating fields have a predefined value indicating that the configurable field is a URI indicating the resources allocated for UEIBR. For example, a HARQ process number field with all bits set to zero, an RF field with all bits set to zero, an MS field with all bits set to one, and an FDRA field associated with a Type 2 FDRA whose all bits are set to zero, or an FDRA field associated with a Type 1 FDRA whose every bits are set to one are examples that may indicate that the configurable field is configured as URI.

The operation flow/algorithmic structure 1000 may include, at 1040, generating UEIBR. The UE 104 may perform the measurement, e.g., L1-RSRP measurement, and generate UEIBR. UE 104 may transmit the UEIBR on the resources allocated by the DCI format.

In some embodiments, the UEIBR may collide with other UCIs. UE 104 may apply collision resolution rules and procedures to resolve collisions and identify the content of the report for the base station. In some instances, the UEIBR may collide with HARQ-ACK feedback, NWI-CSI, or UEIBR of other cells or CCs.

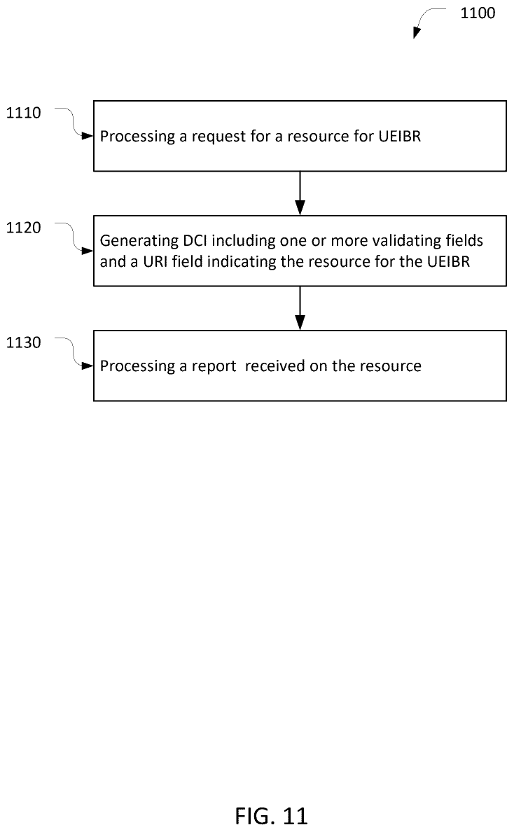

FIG. 11 illustrates an operational flow/algorithmic structure 1100 in accordance with some embodiments. The operation flow/algorithmic structure 1100 may be performed or implemented by a base station such as, for example, the base station 108 or the base station 1300; or components thereof, for example, baseband processor circuitry 1304A.

The operation flow/algorithmic structure 1100 may include, at 1110, processing a message. Base station 108 may receive and process the message from the UE 104. The message may request a resource for an uplink channel to carry UEIBR.

The operation flow/algorithmic structure 1100 may include, at 1120, generating DCI format, including one or more validating fields and a configurable field. One or more validating files may indicate that the configurable field is configured as a URI field to indicate the resource that carries the UEIBR.

Base station 108 may use fields in a legacy DCI format and reconfigure or repurpose them as validating fields. Base station 108 may repurpose the legacy field by assigning values that are not used or are deemed invalid for performing legacy operations. The predetermined unused or invalid values of these fields may indicate that these fields are used as validating fields to indicate that the configurable field of the DCI format is configured as URI. The value of the URI field may indicate the resources for UEIRB.

The operation flow/algorithmic structure 1100 may include, at 1130, processing a report received on the resource. Base station 108 may receive and process a report from the UE 104. The report may be a UEIRB received on the resource identified by the URI.

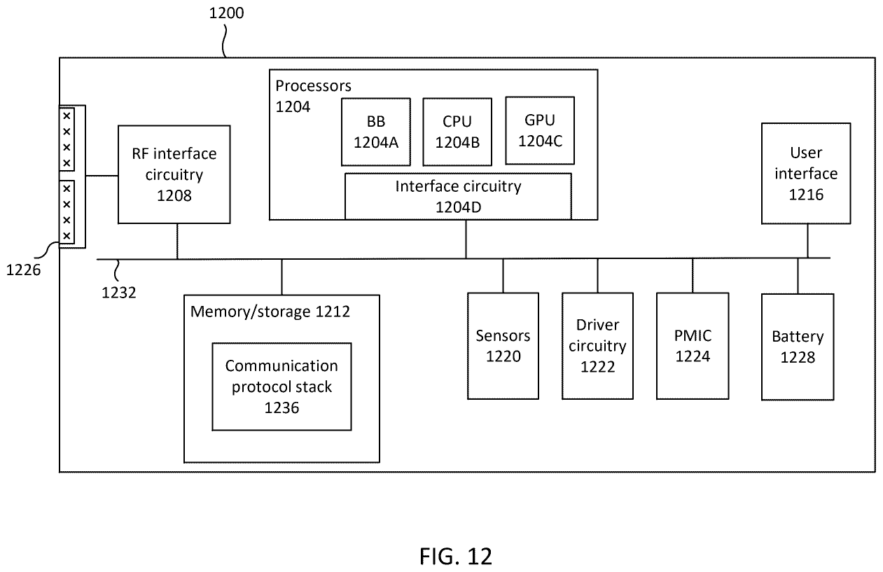

FIG. 12 illustrates a UE 1200 in accordance with some embodiments. The UE 1200 may be similar to and substantially interchangeable with the UE 104.

The UE 1200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smartwatch), or Internet-of-things devices.

The UE 1200 may include processors 1204, RF interface circuitry 1208, memory/storage 1212, user interface 1216, sensors 1220, driver circuitry 1222, power management integrated circuit (PMIC) 1224, antenna 1226, and battery 1228. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and different arrangements of the components shown may occur in other implementations.

The components of the UE 1200 may be coupled with various other components over one or more interconnects 1232, which may represent any type of interface, input/output, bus (local, system, or expansion), transmission line, trace, or optical connection that allows various circuit components (on common or different chips or chipsets) to interact with one another.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage 1212 to cause the UE 1200 to perform operations as described herein. The processors 1204 may also include interface circuitry 1204D to enable communication by, for example, communicatively coupling the processor circuitry with one or more other components of the UE 1200.

In some embodiments, the baseband processor circuitry 1204A may access a communication protocol stack 1236 in the memory/storage 1212 to communicate over a 3GPP-compatible network. In general, the baseband processor circuitry 1204A may access the communication protocol stack 1236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1208.

The baseband processor circuitry 1204A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The memory/storage 1212 may include one or more non-transitory, computer-readable media that include instructions (for example, communication protocol stack 1236) that may be executed by one or more of the processors 1204 to cause the UE 1200 to perform various operations described herein.

The memory/storage 1212 includes any type of volatile or non-volatile memory that may be distributed throughout the UE 1200. In some embodiments, some of the memory/storage 1212 may be located on the processors 1204 themselves (for example, memory/storage 1212 may be part of a chipset that corresponds to the baseband processor circuitry 1204A), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 1208 may include transceiver circuitry and a radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1226 and proceed to filter and amplify (with a low-noise amplifier) the signal. The signal may be provided to a receiver of the transceiver that down-converts the RF signal into a baseband signal that is provided to the baseband processor of the processors 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1226.

In various embodiments, the RF interface circuitry 1208 may be configured to transmit/receive signals in a manner compatible with NR access technologies.

The antenna 1226 may include antenna elements to convert electrical signals into radio waves to travel through the air and to convert received radio waves into electrical signals. The antenna elements may be arranged into one or more antenna panels. The antenna 1226 may have antenna panels that are omnidirectional, directional, or a combination thereof to enable beamforming and multiple input, multiple output communications. The antenna 1226 may include microstrip antennas, printed antennas fabricated on the surface of one or more printed circuit boards, patch antennas, or phased array antennas. The antenna 1226 may have one or more panels designed for specific frequency bands, including bands in FR1 or FR2.

The user interface 1216 includes various input/output (I/O) devices designed to enable user interaction with the UE 1200. The user interface 1216 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1200.

The sensors 1220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various input/output (I/O) devices that may be present within or connected to the UE 1200. For example, driver circuitry 1222 may include a display driver to control and allow access to a display device, a touchscreen driver to control and allow access to a touchscreen interface, sensor drivers to obtain sensor readings of sensors 1220, and control and allow access to sensors 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage the power provided to various components of the UE 1200. In particular, with respect to the processors 1204, the PMIC 1224 may control power-source selection, voltage scaling, battery charging, or DC-to-DC conversion.

A battery 1228 may power the UE 1200, although, in some examples, the UE 1200 may be mounted and deployed in a fixed location and may have a power supply coupled to an electrical grid. The battery 1228 may be a lithium-ion battery, a metal-air battery, such as a zinc-air battery, an aluminum-air battery, a lithium-air battery, and the like. In some implementations, such as in vehicle-based applications, the battery 1228 may be a typical lead-acid automotive battery.

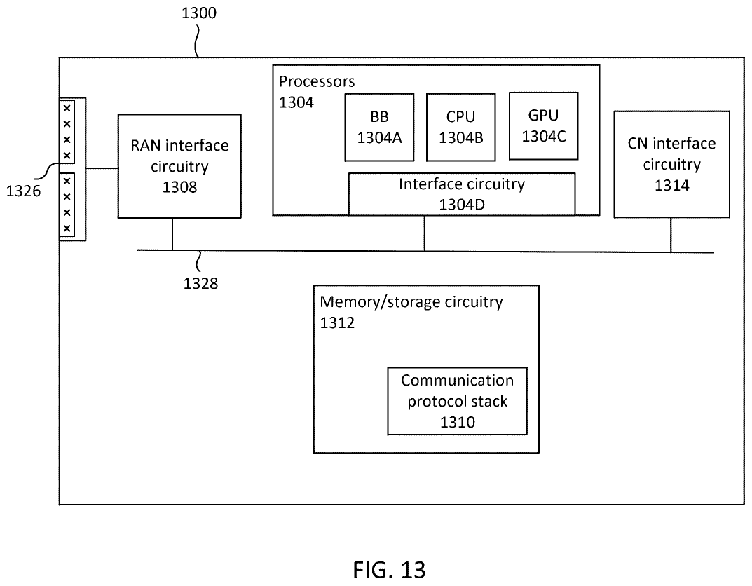

FIG. 13 illustrates a network device 1300 in accordance with some embodiments. The network device 1300 may be similar to and substantially interchangeable with base station 108.

The network device 1300 may include processors 1304, RF interface circuitry 1308 (if implemented as a base station), core network (CN) interface circuitry 1314, memory/storage circuitry 1312, and antenna structure 1326.

The components of the network device 1300 may be coupled with various other components over one or more interconnects 1328.

The processors 1304, RF interface circuitry 1308, memory/storage circuitry 1312 (including communication protocol stack 1310), antenna structure 1326, and interconnects 1328 may be similar to the like-named elements shown and described with respect to FIG. 12.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry, or processor circuitry that executes or otherwise operates computer-executable instructions, such as program code, software modules, or functional processes from memory/storage circuitry 1312 to cause the UE 1200 to perform operations as described herein. The processors 1304 may also include interface circuitry 1304D to communicatively couple the processor circuitry with one or more other components of the network device 1300.

The CN interface circuitry 1314 may provide connectivity to a core network, for example, a 5th Generation Core network (5GC) using a 5GC-compatible network interface protocol such as carrier Ethernet protocols or some other suitable protocol. Network connectivity may be provided to/from the network device 1300 via a fiber optic or wireless backhaul. The CN interface circuitry 1314 may include one or more dedicated processors or FPGAs to communicate using one or more of the aforementioned protocols. In some implementations, the CN interface circuitry 1314 may include multiple controllers to provide connectivity to other networks using the same or different protocols.

It is well understood that the use of personally identifiable information should follow privacy policies and practices generally recognized as meeting or exceeding industry or governmental requirements for maintaining users' privacy. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry described above in connection with one or more of the preceding figures may be configured to operate according to one or more of the examples set forth below. For another example, circuitry associated with a UE, base station, or network element described above in connection with one or more of the preceding figures may be configured to operate according to one or more of the examples set forth below in the example section.

### EXAMPLES

In the following sections, further exemplary embodiments are provided.

Example 1 includes a method including processing downlink control information (DCI) format; identifying one or more validating fields and a configurable field in the DCI format; determining based on the one or more validating fields that the configurable field is configured as an uplink resource indicator (URI) field is to indicate a resource to carry a user equipment (UE)-initiated beam report (UEIBR); and generating the UEIBR for transmission using the resource.

Example 2 includes the method of example 1 or some other examples herein, wherein the URI field includes a value associated with a transmission occasion within a time window.

Example 3 includes the method of examples 1 or 2 or some other examples herein, wherein the one or more validating fields include: a hybrid automatic repeat request (HARQ) process number field; a redundancy version (RV) field; a modulation and coding scheme (MCS) field; or a frequency domain resource allocation (FDRA) field.

Example 4 includes the method of any of examples 1-3 or some other examples herein, wherein said determining based on the one or more validating fields that the configurable field is configured as a URI field includes: determining that a cyclic redundancy check (CRC) field of the DCI format is scrambled with a cell-radio network temporary identifier (C-RNTI); and determining that: every bit of the HARQ process number field is set to zero; every bit of the RV field is set to zero; every bit of the MCS field is set to one; the FDRA field is associated with a Type 2 FDRA and every bit of the FDRA field is set to zero; or the FDRA field is associated with a Type 1 FDRA and every bit of the FDRA field is set to one.

Example 5 includes the method of any of examples 1-4 or some other examples herein, further including: determining that the DCI format is a DCI format 0_1.

Example 6 includes the method of any of examples 1-5 or some other examples herein, further including: generating a message that is to be transmitted to a base station to request a resource for an uplink channel to carry the UEIBR; and processing a radio resource control (RRC) message that includes a UEIBR-radio network temporary identifier (RNTI).

Example 7 includes the method of any of examples 1-6 or some other examples herein, wherein the one or more validating fields include: a cyclic redundancy check (CRC) field; or a channel state information (CSI) request field.

Example 8 includes the method of any of examples 1-7 or some other examples herein, wherein said determining based on the one or more validating fields that the configurable field is configured as a URI field includes: determining that the CRC field of the DCI format is scrambled with the UEIBR-RNTI; and determining that every bit of the CSI request field is set to zero.

Example 9 includes the method of any of examples 1-8 or some other examples herein, further includes: determining, based on said determining that the cyclic redundancy check (CRC) field of the DCI format is scrambled with the UEIBR-RNTI, that the message is successfully received by the base station.

Example 10 includes the method of any of examples 1-9 or some other examples herein, wherein the one or more validating fields include: a channel state information (CSI) request field.

Example 11 includes the method of any of examples 1-10 or some other examples herein, wherein said determining based on the one or more validating fields that the configurable field is configured as the URI includes: determining that the CSI request field in the DCI format is associated with an unused codepoint.

Example 12 includes the method of any of examples 1-11 or some other examples herein, further including: processing a radio resource control (RRC) configuration including a first resource list and a second resource list, wherein a resource of the first resource list is only used for carrying hybrid automatic repeat request (HARQ)-acknowledgment (ACK), and a resource of the second resource list is used for carrying HARQ-ACK and UEIBR.

Example 13 includes the method of any of examples 1-12 or some other examples herein, wherein the one or more validating fields include a cyclic redundancy check (CRC) field, and the method further includes: processing a radio resource control (RRC) message that includes UEIBR-radio network temporary identifier (RNTI).

Example 14 includes the method of any of examples 1-13 or some other examples herein, wherein said determining based on the one or more validating fields that the configurable field is configured as the URI includes: determining that the CRC field of the DCI format is scrambled with the UEIBR-RNTI.

Example 15 includes the method of any of examples 1-14 or some other examples herein, wherein said determining, based on the one or more validating fields that the configurable field is configured as the URI is further based on a physical uplink control channel (PUCCH) resource indicator field of the DCI format.

Example 16 includes the method of any of examples 1-15 or some other examples herein, wherein the one or more validating field is a flag field, and said determining based on the one or more validating fields that the URI field is indicating a resource to carry the UEIBR includes: determining based on the flag field that the resource indicated by the URI is associated with the second resource list.

Example 17 includes the method of any of examples 1-16 or some other examples herein, further including: determining that the UEIBR collides with an uplink control information (UCI); and generating a report based on said determining whether the UEIBR collides with the UCI, the report is to be transmitted to a base station on the resource.

Example 18 includes the method of any of examples 1-17 or some other examples herein, wherein the UCI is a hybrid automatic repeat request (HARQ)-acknowledgment (ACK) report and said generating the report includes: jointly encoding the HARQ-ACK report and the UEIBR.

Example 19 includes the method of any of examples 1-18 or some other examples herein, wherein the UCI is a network-initiated (NWI)-channel state information (CSI) report.

Example 20 includes the method of any of examples 1-19 or some other examples herein, further including: prioritizing the UEIBR over the NWI-CSI report.

Example 21 includes the method of any of examples 1-20 or some other examples herein, wherein the UEIBR is a first UEIBR and the UCI is a second UEIBR: identifying a first event identifier (ID) associated with the first UEIBR, and a second event ID associated with the second UEIBR; and generating a third report by concatenating the first UEIBR and the second UEIBR in increasing order of corresponding event IDs.

Example 22 includes the method of any of examples 1-21 or some other examples herein, further including: determining that a payload of the third report exceeds a maximum number of bits carried by the resource.

Example 23 includes the method of any of examples 1-22 or some other examples herein, further including: determining that the first event ID is smaller than the second event ID; prioritizing the first UEIBR over the second UEIBR based on said determining that the first event ID is smaller than the second event ID; and dropping the second UEIBR.

Example 24 includes the method of any of examples 1-23 or some other examples herein, further including: processing a radio resource control (RRC) configuration including a first priority order associated with the first event ID and a second priority order associated with the second event ID; determining that the first priority order is greater than the second priority order; prioritizing the first UEIBR over the second UEIBR based on said determining that the first priority order is greater than the second priority order; and dropping the second UEIBR.

Example 25 includes the method of any of examples 1-24 or some other examples herein, further including: determining that the NWI-CSI report is not associated with a layer 1 (L1)-reference signal receive power (RSRP) measurement; and prioritizing the UEIBR over the NWI-CSI report based on said determining that the NWI-CSI report is not associated with the L1-RSRP measurement.

Example 26 includes the method of any of examples 1-25 or some other examples herein, further including: determining that the NWI-CSI report is associated with a periodic or a semi-persistent NWI-CSI report; and prioritizing the UEIBR over the NWI-CSI based on said determining that the NWI-CSI report is associated with the periodic or a semi-persistent NWI-CSI report.

Example 27 includes the method of any of examples 1-26 or some other examples herein, further including: determining that the NWI-CSI report is an aperiodic NWI-CSI report; determining that the NWI-CSI report is associated with a primary cell (PCell) or a primary secondary cell (PSCell); and prioritizing NWI-CSI report over the UEIBR based on said determining that the NWI-CSI report is associated with a primary cell (PCell) or a primary secondary cell (PSCell).

Example 28 includes the method of any of examples 1-27 or some other examples herein, further including: determining that the NWI-CSI report is an aperiodic NWI-CSI report; identifying a first cell identifier (ID) associated with the UEIBR and a second cell ID associated with the NWI-CSI report; and prioritizing NWI-CSI report over the UEIBR based on determining that the second cell ID is smaller than the first cell ID, or prioritizing UEIBR based on determining that the first cell ID is smaller than the second cell ID.

Example 29 includes the method of any of examples 1-28 or some other examples herein, further including: processing a first configuration including a first measurement resource set associated with a first cell or component carrier (CC); and processing a second configuration including a second measurement resource set associated with a second cell or CC.

Example 30 includes the method of any of examples 1-29 or some other examples herein, wherein: UEIBR includes two or more blocks; a first block associated with a first measurement result from the first measurement resource set associated with the first cell; a second block associated with a second measurement result from the second measurement resource set associated with the second cell; and each block of the two or more blocks comprises: a cell identifier (ID); a number of reported beams (NRB); a reference signal index; and a measurement result for each reported beam.

Example 31 includes the method of any of examples 1-30 or some other examples herein, wherein: UEIBR includes a cell indicator field (CIF); the CIF includes a bitmap to indicate one or more cells having measurement results; two or more blocks; a first block associated with a first measurement result from the first measurement resource set associated with the first cell; a second block associated with a second measurement result from the second measurement resource set associated with the second cell; and each block of the two or more blocks includes: a number of reported beams (NRB); a reference signal index; and a measurement result for each reported beam.

Example 32 includes the method of any of examples 1-31 or some other examples herein, further including: processing a configuration including a measurement resource set associated with two or more cells.

Example 33 includes a method including: processing a message, received from a user equipment (UE), that is to request a resource for an uplink channel to carry a UE initiated beam report (UEIBR); generating a downlink control information (DCI) format including one or more validating fields and a configurable field, wherein the one or more validating fields are to indicate that the configurable field is configured as an uplink resource indicator (URI) field to indicate the resource to carry the UEIBR; and processing a report received on the resource, the report including the UEIBR.

Example 34 includes the method of example 33 or some other examples herein, wherein the URI field includes a value associated with a transmission occasion within a time window.

Example 35 includes the method of examples 33 or 34 or some other examples herein, wherein the one or more validating fields include: a hybrid automatic repeat request (HARQ) process number field; a redundancy version (RV) field; a modulation and coding scheme (MCS) field; or a frequency domain resource allocation (FDRA) field.

Example 36 includes the method of any of examples 1-35 or some other examples herein, wherein the DCI format is a DCI format 0_1.

Example 37 includes the method of any of examples 1-36 or some other examples herein, further including: generating a radio resource control (RRC) message, including UEIBR-radio network temporary identifier (RNTI).

Example 38 includes the method of any of examples 1-37 or some other examples herein, further including: scrambling a cyclic redundancy check (CRC) field with the UEIBR-RNTI; and setting every bit of a channel state information (CSI) request field to zero.

Example 39 includes the method of any of examples 1-38 or some other examples herein, further including: assigning a channel state information (CSI) request field to an unused codepoint.

Example 40 includes the method of any of examples 1-39 or some other examples herein, further including: generating a radio resource control (RRC) configuration including a first resource list and a second resource list, wherein a resource of the first resource list is only used for carrying hybrid automatic repeat request (HARQ)-acknowledgment (ACK), and a resource of the second resource list is used for carrying HARQ-ACK and UEIBR.

Example 41 includes the method of any of examples 1-40 or some other examples herein, further including: generating a radio resource control (RRC) message, including UEIBR-radio network temporary identifier (RNTI); and scrambling a cyclic redundancy check (CRC) field of the DCI format with the UEIBR-RNTI.

Example 42 includes the method of any of examples 1-41 or some other examples herein, wherein the DCI format includes a flag field, the flag field is to indicate the URI is associated with the first or second resource list.

Example 43 includes the method of any of examples 1-42 or some other examples herein, further including: generating a radio resource control (RRC) configuration including a first priority order associated with a first event ID and a second priority order associated with a second event ID.

Example 44 includes the method of any of examples 1-40 or some other examples herein, further including: generating a first configuration including a first measurement resource set associated with a first cell; and generating a second configuration including a second measurement resource set associated with a second cell.

Example 45 includes the method of any of examples 1-44 or some other examples herein, further including: processing a UEIBR, wherein: UEIBR includes two or more blocks; a first block associated with a first measurement result from the first measurement resource set associated with the first cell; a second block associated with a second measurement result from the second measurement resource set associated with the second cell; and each block of the two or more blocks includes: a cell identifier (ID); a number of reported beams (NRB); a reference signal index; and a measurement result for each reported beam.

Example 46 includes the method of any of examples 1-45 or some other examples herein, further including: processing a UEIBR, wherein: UEIBR includes a cell indicator field (CIF); the CIF including a bitmap to indicate one or more cells having measurement results; two or more blocks; a first block associated with a first measurement result from the first measurement resource set associated with the first cell; a second block associated with a second measurement result from the second measurement resource set associated with the second cell; and each block of the two or more blocks includes: a number of reported beams (NRB); a reference signal index; and a measurement result for each reported beam.

Example 47 includes the method of any of examples 1-46 or some other examples herein, further including: processing a configuration including a measurement resource set associated with two or more cells.

Another example may include an apparatus comprising means to perform one or more elements of a method described in or related to any of examples 1-47, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-47, or any other method or process described herein.

Another example may include an apparatus comprising logic, modules, or circuitry to perform one or more elements of a method described in or related to any of examples 1-47, or any other method or process described herein.

Another example may include a method, technique, or process as described in or related to any of examples 1-47, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-47, or portions thereof.

Another example may include a signal as described in or related to any of examples 1-47, or portions or parts thereof.

Another example may include a datagram, information element, packet, frame, segment, PDU, or message as described in or related to any of examples 1-47, or portions or parts thereof, or otherwise described in the present disclosure.

Another example may include a signal encoded with data as described in or related to any of examples 1-47, or portions or parts thereof, or otherwise described in the present disclosure.

Another example may include a signal encoded with a datagram, IE, packet, frame, segment, PDU, or message as described in or related to any of examples 1-47, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-47, or portions thereof.

Another example may include a computer program comprising instructions, wherein execution of the program by a processing element is to cause the processing element to carry out the method, techniques, or process as described in or related to any of examples 1-47, or portions thereof.

Another example may include a signal in a wireless network as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing a downlink control information (DCI) format that includes one or more validating fields and a configurable field;
determining based on the one or more validating fields in the DCI format that the configurable field is configured as an uplink resource indicator (URI) field to indicate an uplink resource to carry a user equipment (UE)-initiated beam report (UEIBR); and
generating the UEIBR for transmission using the uplink resource.

2. The method of claim 1, wherein the URI field includes a value to indicate a transmission occasion, within a time window, that corresponds to the uplink resource.

3. The method of claim 1, wherein the one or more validating fields include:
a hybrid automatic repeat request (HARQ) process number field;
a redundancy version (RV) field;
a modulation and coding scheme (MCS) field; or
a frequency domain resource allocation (FDRA) field.

4. The method of claim 3, wherein said determining based on the one or more validating fields that the configurable field is configured as a URI field comprises determining that:
every bit of the HARQ process number field is set to zero;
every bit of the RV field is set to zero;
every bit of the MCS field is set to one;
the FDRA field is associated with a Type 2 FDRA and every bit of the FDRA field is set to zero; or
the FDRA field is associated with a Type 1 FDRA and every bit of the FDRA field is set to one.

5. The method of claim 1, wherein the one or more validating fields include a cyclic redundancy check (CRC) field and a channel state information (CSI) request field, and wherein said determining based on the one or more validating fields that the configurable field is configured as a URI field comprises:
determining that the CRC field of the DCI format is scrambled with a UEIBR-radio network temporary identifier (RNTI); and
determining that every bit of the CSI request field is set to zero.

6. The method of claim 1, further comprising receiving a radio resource control (RRC) message that indicates a UEIBR-radio network temporary identifier (RNTI), wherein the one or more validating fields of the DCI format include a cyclic redundancy check (CRC) field scrambled with the UEIBR-RNTI, and wherein the configurable field includes a channel state information (CSI) request field with a codepoint to indicate the uplink resource for the UEIBR.

7. The method of claim 1, wherein the configurable field includes a physical uplink control channel (PUCCH) resource indicator field, and wherein the method further comprises:
receiving a radio resource control (RRC) configuration including a first resource list and a second resource list associated with the PUCCH resource indicator field, wherein resources of the first resource list are used for carrying hybrid automatic repeat request (HARQ)-acknowledgment (ACK) feedback and not UEIBR messages, and resources of the second resource list are used for carrying HARQ-ACK feedback and UEIBR messages.

8. The method of claim 7, wherein:
the one or more validating fields include a cyclic redundancy check (CRC) field, and wherein a cyclic redundancy check (CRC) field of the DCI format is scrambled with a UEIBR-radio network temporary identifier (RNTI) to indicate that the PUCCH resource indicator field is to indicate the uplink resource from the second resource list; or
the one or more validating fields include a flag field, and wherein the flag field is to have a first value to indicate that the PUCCH resource indicator field is to indicate the uplink resource from the second resource list.

9. The method of claim 1, further comprising:
determining that the UEIBR collides with a network-initiated (NWI)-channel state information (CSI) report in the uplink resource; and
prioritizing transmission of the UEIBR over the NWI-CSI in the uplink resource based on:
the UEIBR being associated with a primary cell or a primary secondary cell (PSCell) and the NWI-CSI report being associated with a secondary cell (SCell);
the UEIBR being associated with a lower cell identifier (ID) than the NWI-CSI report;
priority information configured via radio resource control (RRC) signaling, wherein the priority information includes a relative priority of the UEIBR and the NWI-CSI report on a per event basis;
the NWI-CSI report not carrying a layer 1 (L1)-reference signal received power (RSRP) measurement; or
the NWI-CSI report being a periodic or semi-persistent NWI-CSI report.

10. The method of claim 1, further comprising:
processing a first configuration including a first measurement resource set associated with a first cell or component carrier (CC); and
processing a second configuration including a second measurement resource set associated with a second cell or CC, wherein the UEIBR includes two or more blocks, including a first block associated the first measurement resource set and a second block associated with the second measurement resource set, and wherein:
individual blocks of the two or more blocks indicate a respective cell identifier (ID); or
the UEIBR includes a cell indicator field (CIF) to indicate cells or CCs corresponding to respective individual blocks of the two or more blocks.

11. A method comprising:
processing a message, received from a user equipment (UE), that is to request an uplink resource to carry a UE-initiated beam report (UEIBR);
generating, for transmission to the UE, a downlink control information (DCI) format including one or more validating fields and a configurable field, wherein the one or more validating fields are to indicate that the configurable field is configured as an uplink resource indicator (URI) field to indicate the uplink resource to carry the UEIBR; and
processing the UEIBR received on the uplink resource.

12. The method of claim 11, wherein the URI field includes a value to indicate a transmission occasion, within a time window, that corresponds to the uplink resource.

13. The method of claim 11, wherein the one or more validating fields include:
a hybrid automatic repeat request (HARQ) process number field;
a redundancy version (RV) field;
a modulation and coding scheme (MCS) field; or
a frequency domain resource allocation (FDRA) field.

14. The method of claim 11, further comprising:
generating, for transmission to the UE, a radio resource control (RRC) message that indicates a UEIBR-radio network temporary identifier (RNTI), wherein the one or more validating fields of the DCI format include a cyclic redundancy check (CRC) field scrambled with the UEIBR-RNTI, and wherein the configurable field includes a channel state information (CSI) request field with a codepoint to indicate the uplink resource for the UEIBR.

15. The method of claim 11, further comprising:
generating, for transmission to the UE, a radio resource control (RRC) configuration including a first resource list and a second resource list, wherein a resource of the first resource list is only used for carrying hybrid automatic repeat request (HARQ)-acknowledgment (ACK), and a resource of the second resource list is used for carrying HARQ-ACK and the UEIBR.

16. The method of claim 15, wherein:
a cyclic redundancy check (CRC) field of the DCI format is scrambled with a UEIBR-radio network temporary identifier (RNTI) to indicate that the URI is to indicate the uplink resource from the second resource list; or
the DCI format includes a flag to indicate whether the URI is associated with the first or second resource list.

17. The method of claim 11, further comprising:
generating, for transmission to the UE, configuration information to indicate a first measurement resource set associated with a first cell or component carrier (CC) and a second measurement resource set associated with a second cell or CC, wherein the UEIBR includes two or more blocks, including a first block associated the first measurement resource set and a second block associated with the second measurement resource set, and wherein:
individual blocks of the two or more blocks indicate a respective cell identifier (ID); or
the UEIBR includes a cell indicator field (CIF) to indicate cells or CCs corresponding to respective individual blocks of the two or more blocks.

18. An apparatus comprising:
processor circuitry to:
identify that a user equipment (UE)-initiated beam report (UEIBR) collides with a network-initiated (NWI)-channel state information (CSI) report in an uplink resource; and
determine, based on the identification and one or more collision rules, whether to transmit the UEIBR or the NWI-CSI report in the uplink resource; and
generate a report for transmission in the uplink resource, the report to include the UEIBR or the NWI-CSI report based on the determination; and
interface circuitry coupled to the processor circuitry to enable communication.

19. The apparatus of claim 18, wherein the NW-CSI report is an aperiodic NWI-CSI report, and the processor circuitry is further to prioritize a first one of the UEIBR or the NWI-CSI report over a second one of the UEIBR or the NWI-CSI report based on:
the first one being associated with a primary cell or a primary secondary cell (PSCell) and the second one being associated with a secondary cell (SCell);
the first one being associated with a lower cell identifier (ID) than the second one; or
priority information configured via radio resource control (RRC) signaling, wherein the priority information includes a relative priority of the UEIBR and the NWI-CSI report on a per event basis.

20. The apparatus of claim 18, wherein the processor circuitry is further to prioritize the UEIBR over the NWI-CSI report based on:
the NWI-CSI report not carrying a layer 1 (L1)-reference signal received power (RSRP) measurement; or
the NWI-CSI report being a periodic or semi-persistent NWI-CSI report.
